(19) United States
(12) Patent Application Publication
(10) Pub. No.: US 2024/0368426 A1
(43) Pub. Date: Nov. 7, 2024

(54) RELEASE COATING COMPOSITION

(71) Applicant: Dow Silicones Corporation, Midland, MI (US)

(72) Inventors: Fuming Huang, Shanghai (CN); Wenchao Wang, Shanghai (CN); Shenglan Zhang, Shanghai (CN); Zhihua Liu, Shanghai (CN)

(21) Appl. No.: 18/689,447

(22) PCT Filed: Dec. 21, 2021
(86) PCT No.: PCT/CN2021/140123

§ 371 Date: Mar. 6, 2024

(51) Int. Cl. C09D 183/04; C08K 3/36; C08K 5/5419; C08K 9/02; C09D 7/63; C09J 7/40

(52) U.S. Cl. CPC C09D 183/04; C09D 7/63; C09J 7/401; C08K 3/36; C08K 5/5419; C08K 9/02; C09J 2483/005

(57) ABSTRACT

A curable release coating composition contains: (A) an aliphatically unsaturated polyorganosiloxane having two or more alkenyl groups per molecule; (B) a crosslinker having two or more silicon-bonded hydrogen atoms per molecule in an amount sufficient to provide a molar ratio of silicon-bonded hydrogen atoms to alkenyl groups in the curable release coating composition of 0.8:1 to 5:1; (C) a hydrosilylation reaction catalyst in a catalytic amount; and (D) from 0.01% to 5% by weight, based on the weight of the curable release coating composition excluding solvent if present, of particles of a cured organosiloxane composition, optionally with silica treated coating, having an average particle size of 0.5 to 30 micrometers.

### FIELD

The present invention relates to a curable release coating composition and a release liner prepared by applying the release coating composition to a substrate such as a plastic film or paper and curing the release coating composition via thermal addition.

### INTRODUCTION

Silicone release coatings are useful in applications where relatively non-adhesive surfaces are required. Single sided liners, such as backing papers or films for pressure sensitive adhesive labels, are usually adapted to temporarily retain the labels without affecting the adhesive properties of the labels. Double sided liners, such as interleaving papers or films for double sided and transfer tapes, are used to protect the self-adhesive tapes. These liners are generally manufactured in long sheets which are then rolled up to provide for easy shipping and storage. Conventional silicone release coating compositions may achieve an ultra-low release force (e.g., <5.0 grams per inch) to an adhesive typically at coat weights >1.0 gram per square meter, but suffer from blocking issues in which adjacent layers often stick together between successive liner rolls during storage. Incorporation of silica particles into silicone release coating compositions can prevent blocking when coating on substrates, but it often makes the resultant release coating appear hazy, which limit the use of silicone release coatings for tape release, label release, and adhesive transfer films. Particularly, many electronic device applications require transparent release coatings. The release coatings are desirable to have anti-blocking properties in order to increase production efficiency and avoid potential coatings damages when separating two coated surfaces that are stacked or placed in contact with one another during storage, packaging and/or shipping of the resultant release liners that are wound up into large rolls.

There remains a need to identify a release coating composition that can provide release coatings with the above described low release force with clear appearance and anti-blocking property, while maintaining other properties including subsequent adhesion strength.

### SUMMARY

The present invention provides a curable release coating composition that can cure into a cured release coating that has a low release force to an adhesive with clear appearance and anti-blocking property. The release coating composition of the present invention comprises a novel combination of an aliphatically unsaturated polyorganosiloxane, a crosslinker, and a hydrosilylation reaction catalyst with a specific amount of particles of a cured organosiloxane composition, optionally with silica treated coating. The release coating composition can be coated on at least one surface of a substrate and cured via hydrosilylation reaction to prepare a release liner.

In a first aspect, the present invention is a curable release coating composition comprising:
(A) an aliphatically unsaturated polyorganosiloxane having two or more alkenyl groups per molecule;
(B) a crosslinker having two or more silicon-bonded hydrogen atoms per molecule in an amount sufficient to provide a molar ratio of silicon-bonded hydrogen atoms to alkenyl groups in the curable release coating composition of 0.8:1 to 5:1;
(C) a hydrosilylation reaction catalyst in a catalytic amount; and
(D) from 0.01% to 5% by weight, based on the weight of the curable release coating composition excluding solvent if present, of particles of a cured organosiloxane composition, optionally with silica treated coating, having an average particle size of 0.5 to 30 micrometers.

In a second aspect, the present invention is a method of preparing a release liner comprising a release coating on at least one surface of a substrate, comprising:
optionally treating at least one surface of the substrate,
1) applying the curable release coating composition of the first aspect to the surface of the substrate, optionally 2) removing solvent, if present; and
3) curing the composition to form the release coating on the surface of the substrate.

In a third aspect, the present invention is a release liner comprising a substrate and a release coating residing on at least one surface of the substrate, wherein the release coating is formed by curing the curable release coating composition of the first aspect.

### BRIEF DESCRIPTION OF THE DRAWINGS

FIG. 1 shows a partial cross section of a release liner 100. The release liner comprises a release coating 101 prepared by curing the curable release composition of the present invention on a first surface 102 of a film substrate 103. The release liner 100 further includes a carrier 104 mounted to an opposing surface 105 of the film substrate 103.

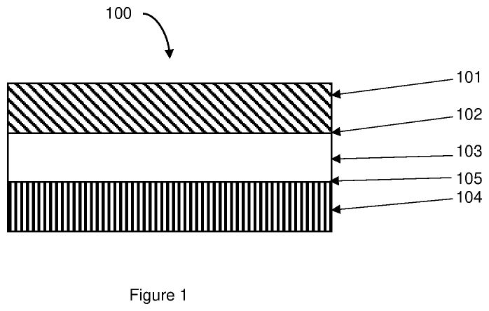

### DETAILED DESCRIPTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods.

Products identified by their tradename refer to the compositions available under those tradenames on the priority date of this document.

“And/or” means “and, or as an alternative”. All ranges include endpoints unless otherwise indicated.

“Viscosity” for a polysiloxane is measured at 25 degrees Celsius (° C.) by a Brookfield DV2T Viscometer with spindle LV1.

Determine chemical structure for polysiloxanes by standard ¹H, ¹³C and ²⁹Si nuclear magnetic resonance (NMR) analysis.

“Alkyl” herein means a cyclic, branched, or unbranched, saturated monovalent hydrocarbon group. Examples of alkyl groups include methyl, ethyl, propyl (e.g., iso-propyl and/or n-propyl), butyl (e.g., isobutyl, n-butyl, tert-butyl, and/or sec-butyl), pentyl (e.g., isopentyl, neopentyl, and/or tert-pentyl), hexyl, heptyl, octyl, nonyl, and decyl, and branched alkyl groups of 6 or more carbon atoms; and cyclic alkyl groups such as cyclopentyl and cyclohexyl.

“Aryl” herein means a cyclic, fully unsaturated, hydrocarbon group. Aryl is exemplified by, but not limited to, cyclopentadienyl, phenyl, anthracenyl, and naphthyl. Monocyclic aryl groups may have from 5 to 9 carbon atoms, from 6 to 7 carbon atoms, or from 5 to 6 carbon atoms. Polycyclic aryl groups may have from 10 to 17 carbon atoms, from 10 to 14 carbon atoms, or from 12 to 14 carbon atoms.

“Aralkyl” herein means an alkyl group having a pendant and/or terminal aryl group or an aryl group having a pendant alkyl group. Exemplary aralkyl groups include tolyl, xylyl, benzyl, phenylethyl, phenyl propyl, and phenyl butyl.

“Alkenyl” herein means a branched or unbranched, monovalent hydrocarbon group having one or more carbon-carbon double bonds.

The curable release coating composition of the present invention comprises (A) one or more aliphatically unsaturated polyorganosiloxanes having two or more alkenyl groups per molecule. The aliphatically unsaturated polyorganosiloxanes (A) can be selected from (A-1) a Q-branched polyorganosiloxane, (A-2) a silsesquioxane, (A-3) a linear polyorganosiloxane, or combinations of two or more of (A-1), (A-2), and (A-3).

The Q-branched polyorganosiloxane (A-1) useful in the present invention may have unit formula (A-I):

(R¹₃SiO_{1/2})ₐ(R²R¹₂SiO_{1/2})(R¹₂SiO_{2/2})_{c}(R²R¹SiO_{2/2})_{c′}(SiO_{4/2})_{d} (A-I),
where each R¹ is independently a monovalent hydrocarbon group free of aliphatic unsaturation or a monovalent halogenated hydrocarbon group free of aliphatic unsaturation, each R² is independently an alkenyl group, subscript a≥0, subscript b>0, 995≥c+c′≥15, and subscript d>0.

The monovalent hydrocarbon group for R¹ is exemplified by an alkyl group of 1 to 6 carbon atoms, an aryl group of 6 to 10 carbon atoms, a halogenated alkyl group of 1 to 6 carbon atoms, or a halogenated aryl group of 6 to 10 carbon atoms. Suitable alkyl groups for R¹ may include, for example, methyl, ethyl, propyl (e.g., iso-propyl and/or n-propyl), butyl (e.g., isobutyl, n-butyl, tert-butyl, and/or sec-butyl), pentyl (e.g., isopentyl, neopentyl, and/or tert-pentyl), hexyl, as well as branched saturated hydrocarbon groups of 6 carbon atoms. Suitable aryl groups for R¹ are exemplified by phenyl, tolyl, xylyl, naphthyl, benzyl, and dimethyl phenyl. Suitable halogenated alkyl groups for R¹ are exemplified by, but not limited to, the alkyl groups described above where one or more hydrogen atoms is replaced with a halogen atom, such as F or C1. For example, fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, and 3,4-difluoro-5-methylcycloheptyl, chloromethyl, chloropropyl, 2-dichlorocyclopropyl, and 2,3-dichlorocyclopentyl are examples of suitable halogenated alkyl groups. Suitable halogenated aryl groups for R¹ are exemplified by, but not limited to, the aryl groups described above where one or more hydrogen atoms is replaced with a halogen atom, such as F or Cl. For example, chlorobenzyl and fluorobenzyl are suitable halogenated aryl groups. Each R¹ may be the same or different. Each R¹ can be an alkyl group. Desirably, each R¹ is independently methyl, ethyl, or propyl, and more desirably, each R¹ is methyl.

The alkenyl group for R² is capable of undergoing hydrosilylation reaction. The alkenyl group represented by R² typically have from 2 to 8 carbon atoms, from 2 to 6 carbon atoms, or from 2 to 4 carbon atoms. Suitable alkenyl groups for R² are exemplified by an such as vinyl, allyl, butenyl, and hexenyl. Each R² may be same or different. Desirably, each R² is selected from vinyl or hexenyl. Each R² can be a vinyl group.

In the unit formula (A-I), subscript a can be zero or more (≥0), and is generally 22 or less, and can be 20 or less, 15 or less, 10 or less, or even 5 or less. Subscript b is greater than zero (>0), and can be >1, or 2 or more, 3 or more, or even 4 or more, while at the same time is generally 22 or less, and can be 20 or less, 15 or less, or even 10 or less. Subscript c may be in a range of 15 to 995, and can be 15 or more, 50 or more, or even 100 or more, while at the same time is generally 995 or less, and can be 800 or less, or even 400 or less. Subscript c′ can be zero or more, and can be 1 or more, 5 or more, or even 10 or more, while at the same time is generally 995 or less, and can be 800 or less, or even 400 or less. Subscript d is greater than zero (>0), and can be 1 or more, while at the same time is generally 10 or less, 5 or less, or even 1 or less. Desirably, subscript d is 1 or 2. When subscript d=1, subscript a may be zero and subscript b may be 4.

The subscripts in the unit formula (A-I) above may have values sufficient to provide the vinyl content of the Q-branched polyorganosiloxane (A-1) of 0.1% or more, and can be 0.15% or more, or even 0.2% or more, while at the same time is generally 5.0% or less, 2.0% or less, 1.5% or less, 1.0% or less, or even 0.8% or less, by weight based on the weight of the Q-branched polyorganosiloxane (A-1).

The Q-branched polyorganosiloxane (A-1) may contain at least two polydiorganosiloxane chains of formula (R¹₂SiO_{2/2})_{y}, where each subscript y is independently 2 to 100. Alternatively, the branched siloxane may comprise at least one unit of formula (SiO₄/2) bonded to four polydiorganosiloxane chains of formula (R¹₂SiO_{2/2})_{z}, where each subscript z is independently 1 to 100.

The Q-branched polyorganosiloxane (A-1) may be one Q-branched polyorganosiloxane or a combination of two or more Q-branched polyorganosiloxanes of unit formula (A-I) that may differ in one or more properties selected from molecular weight, structure, siloxane units and sequence. Suitable Q-branched polyorganosiloxanes may include those disclosed in U.S. Pat. No. 6,806,339.

The silsesquioxane (A-2) useful in the present invention may have unit formula (A-II):

(R¹₃SiO_{1/2})ₑ(R²R¹₂SiO_{1/2})(R¹₂SiO_{2/2})_{g}(R¹SiO_{3/2})ₕ (A-II),
where R¹ and R² are as described above in the unit formula (A-I), subscript e≥0, subscript f>0, subscript g is 15 to 995, and subscript h>0. Desirably, each R¹ is methyl. Desirably, R² is vinyl.

Subscript e may be zero or more, and can be 1 or more, 2 or more, or even 3 or more, while at the same time is generally 12 or less, and can be 10 or less, 7 or less, 5 or less, or even 3 or less. Subscript f may be greater than zero (>0), and can be 1 or more, or even greater than 1, while at the same time is generally 12 or less, and can be 10 or less, 7 or less, 5 or less, 3 or less, or even 2 or less. Subscript g may be 15 or more, and can be 20 or more, 50 or more, or even 100 or more, while at the same time is generally 995 or less, and can be 800 or less, 400 or less, or even 200 or less. Subscript h may be greater than 0 (>0), and can be 1 or more, or even 2 or more, while at the same time is generally 10 or less, 8 or less, 5 or less, 2 or less, or even 1 or less. When subscript h=1, subscript f may be 3 and subscript e may be 0.

The values for subscript f may be sufficient to provide the silsesquioxane of unit formula (A-II) with an alkenyl content of 0.1% or more, and can be 0.15% or more, 0.2% or more, or even 0.24% or more, while at the same time is generally 1% or less, and can be 0.8% or less, or even 0.6% or less, by weight based on the weight of the silsesquioxane (A-2).

The silsesquioxane may be one silsesquioxane or a combination of two or more silsesquioxanes of unit formula (A-II) that may differ in one or more properties selected from molecular weight, structure, siloxane units and sequence. Suitable silsesquioxanes (A-2) may include those disclosed in U.S. Pat. No. 4,374,967.

The linear polydiorganosiloxane (A-3) useful in the present invention may have alkenyl groups that can be located at terminal positions, at pendant positions, or at both terminal and pendant positions. Desirably, the polydiorganosiloxane has an average of one or more terminally alkenyl groups per molecule. The polydiorganosiloxane (A-3) may comprise one or more than one polysiloxane having unit formula selected from (A-III-1), (A-III-2), or combinations thereof:

(R¹₂R²SiO_{1/2})₂(R¹₂SiO)ₙ(R¹R²SiO)ₒ (A-III-1),

(R¹₃SiO_{1/2})₂(R¹₂SiO)ₚ(R¹R²SiO)_{q} (A-III-2),
where R¹ and R² are described above in the unit formula (A-I), subscript n is 5 to 10,000, and subscript o has a value sufficient to provide an alkenyl content of 0.01% to 5.0%, from 0.05% to 2.0%, from 0.10% to 1.5%, from 0.2% to 1.0%, by weight based on weight of the polydiorganosiloxane of unit formula (A-III-1). Subscript p is 5 to 10,000, and subscript q is sufficient to provide an alkenyl content of 0.01% to 5.0%, and can be 0.01% or more, 0.05% or more, 0.10% or more, or even 0.2% or more, while at the same time is generally 5.0% or less, and can be 2.0%, 1.5% or less, or even 1.0% or less, by weight based on weight of the polydiorganosiloxane of unit formula (A-III-2).

The polydiorganosiloxane (A-3) may comprise one polydiorganosiloxane or a combination of two or more polydiorganosiloxanes that may differ in one or more properties selected from molecular weight, structure, siloxane units and sequence. The polydiorganosiloxane (A-3) may comprise any one or any combination of more than one of the following polydiorganosiloxanes:
i) dimethylvinylsiloxy-terminated polydimethylsiloxane,
ii) dimethylvinylsiloxy-terminated poly(dimethylsiloxane/methylvinylsiloxane),
iii) dimethylvinylsiloxy-terminated polymethylvinylsiloxane,
iv) trimethylsiloxy-terminated poly(dimethylsiloxane/methylvinylsiloxane),
v) trimethylsiloxy-terminated polymethylvinylsiloxane,
vi) dimethylvinylsiloxy-terminated poly(dimethylsiloxane/methylvinylsiloxane),
vii) dimethylvinylsiloxy-terminated poly(dimethylsiloxane/methylphenylsiloxane),
viii) dimethylvinylsiloxy-terminated poly(dimethylsiloxane/diphenylsiloxane),
ix) phenyl,methyl,vinyl-siloxy-terminated polydimethylsiloxane,
x) dimethylhexenylsiloxy-terminated polydimethylsiloxane,
xi) dimethylhexenylsiloxy-terminated poly(dimethylsiloxane/methylhexenylsiloxane),
xii) dimethylhexenylsiloxy-terminated polymethylhexenylsiloxane,
xiii) trimethylsiloxy-terminated poly(dimethylsiloxane/methylhexenylsiloxane),
xiv) trimethylsiloxy-terminated polymethylhexenylsiloxane,
xv) dimethylhexenyl-siloxy terminated poly(dimethylsiloxane/methylhexenylsiloxane), and
xvi) dimethylvinylsiloxy-terminated poly(dimethylsiloxane/methylhexenylsiloxane).

The curable release coating composition of the present invention also comprises (B) one or more crosslinkers having two or more, or even 3 or more, silicon-bonded hydrogen (SiH) atoms per molecule (also as “SiH crosslinker”). The SiH crosslinker may have a concentration of hydrogen atom (H) as SiH (i.e., the concentration of silicon-bonded hydrogen atom), of 0.1% or more, and can be 0.2% or more, 0.3% or more, 0.4% or more, 0.5% or more, 0.6% or more, 0.7% or more, 0.8% or more, or even 0.9% or more, while at the same time is generally 1.0% or less, and can be 0.9% or less, 0.8% or less, 0.7% or less, 0.6% or less, 0.5% or less, 0.4% or less, or even 0.3% or less, by weight based on weight of the SiH crosslinker. The content of silicon-bonded hydrogen atoms can be determined by NMR analysis.

The SiH crosslinker may be a polyorganohydrogensiloxane crosslinker of unit formula (B-I):

(R¹₃SiO_{1/2})₂(R₂SiO_{2/2})ₖ(R¹HSiO_{2/2})ₘ (B-I),
where R¹ is as described above in the unit formula (A-I), subscript k≥0, subscript m>0, and a quantity (m+k) is 8 to 400. Subscripts m and k may have values selected such that the polyorganohydrogensiloxane crosslinker has a viscosity of from 5 to 1,000 milliPascal*seconds (mPa·s) at 25° C., from 10 to 350 mPa·s at 25° C., or from 20 to 100 mPa·s at 25° C. Suitable polyorganohydrogensiloxane crosslinkers may include, for example, trimethylsiloxy-terminated poly(dimethylsiloxane/methylhydrogensiloxane), trimethylsiloxy-terminated polymethylhydrogensiloxane, or mixtures thereof. The crosslinker may be one polyorganohydrogensiloxane crosslinker or a combination of two or more crosslinkers that may differ in one or more properties selected from molecular weight, structure, siloxane units and sequence. Suitable commercially available SiH crosslinkers include those available under the names HMS-071, HMS-301 and DMS-H11 all available from Gelest.

The relative concentration of the aliphatically unsaturated polyorganosiloxane (A) and the SiH crosslinker is such that the molar ratio of silicon-bonded hydrogen atoms from the crosslinker to alkenyl groups in the curable release coating composition (e.g., alkenyl groups in the aliphatically unsaturated polyorganosiloxane (A)) (SiH/Vi ratio) is in a range of 0.8:1 to 5:1, and can be 0.8:1 or more, 0.9:1 or more, 1.0:1 or more, 1.1:1 or more, 1.2:1 or more, 1.3:1 or more, 1.4:1 or more, 1.5:1 or more, or even 1.6:1 or more, while at the same time is generally 5:1, and can be 4:1 or less, 3:1 or less, 2:1 or less, 1.9:1 or less, 1.8:1 or less, 1.7:1 or less, or even 1.6:1 or less.

Typically, the SiH crosslinker is present at a concentration of 0.1% or more, and can be 1% or more, 1.5% or more, 1.8% or more, or even 2% or more, while at the same time is generally 5% or less, and can be 4% or less, 3% or less, or even 2.5% or less, by weight based on the total weight of components containing alkenyl groups in the curable release coating composition.

The curable release coating composition of the present invention comprises (C) one or more hydrosilylation reaction catalysts. Hydrosilylation reaction catalysts may include platinum group metal catalysts. Such hydrosilylation reaction catalysts may comprise (C1) a metal selected from platinum, rhodium, ruthenium, palladium, osmium, and iridium, preferably, platinum; (C2) a compound of such a metal including, for example, chloridotris(triphenylphosphane)rhodium(I) (Wilkinson's Catalyst), a rhodium diphosphine chelate such as [1,2-bis(diphenylphosphino)ethane]dichlorodirhodium or [1,2-bis(diethylphospino)ethane]dichlorodirhodium, chloroplatinic acid (Speier's Catalyst), chloroplatinic acid hexahydrate, or platinum dichloride, (C3) a complex of the metal compound (C2) with an organopolysiloxane such as 1,3-diethenyl-1,1,3,3-tetramethyldisiloxane complexes with platinum (Karstedt's Catalyst). The hydrosilylation catalyst can be encapsulated (typically, in a phenyl resin) or non-encapsulated. Exemplary hydrosilylation reaction catalysts are described in U.S. Pat. Nos. 3,159,601 and 3,220,972.

The amount of the hydrosilylation reaction catalyst is used in a catalytic amount, that is, an amount sufficient to catalyze hydrosilylation reaction of silicon bonded hydrogen atoms and alkenyl groups in the curable release coating composition. Typically, the concentration of the hydrosilylation reaction catalyst is sufficient to provide 1 part per million (ppm) or more, 5 ppm or more, 10 ppm or more, 20 ppm or more, or even 30 ppm or more, while at the same time is generally 1,000 ppm or less, 500 ppm or less, 300 ppm or less, 130 ppm or less, or even 100 ppm or less, of a platinum group metal, by weight based on the weight of the curable release coating composition excluding solvent if present (e.g., the total weight of the components (A), (B) and (C) described above, and (D) below, and optional components (E), (F), and (H) below if present).

The curable release coating composition of the present invention comprises (D) particles of a cured organosiloxane composition (also as “cured organosiloxane particles”), optionally with silica treated coating. The shape of the particles of the cured organosiloxane composition may be spherical, flat, or amorphous. A spherical shape is preferred. The particles of the cured organosiloxane composition may have an average particle size of 0.5 micrometer (μm) or more, and can be 1 μm or more, 2 μm or more, or even 3 μm or more, while at the same time is generally 30 μm or less, and can be 25 μm or less, 20 μm or less, 15 μm or less, 14 μm or less, 13 μm or less, 12 μm or less, 10 μm or less, 9 μm or less, 8 μm or less, or even 6 μm or less, as determined using Malvern Mastersizer Hydro 2000SM (further details provided under Particle Size of Cured Organosiloxane Composition below).

The particles of the cured organosiloxane composition can have or be free of silica treated coating. Particles having or with “silica treated coating” means these particles have been treated or coated with silica, such that silica microparticles are present, typically immobilized, on the surface of particles of the cured organosiloxane composition. Desirably, the particles of the cured organosiloxane composition with the silica treated coating comprise amorphous silica microparticles that are immobilized on the surface of particles of the cured organosiloxane composition. The amorphous silica microparticles may have an average particle diameter of 1 μm or less, and can be 0.5 μm or less, 0.1 μm or less, 0.05 μm or less, 0.02 μm or less, or even 0.01 μm or less, as determined by Malvern Mastersizer Hydro 2000SM (further details provided under Particle Size of Amorphous Silica Microparticles). The amorphous silica microparticles may exhibit a surface silanol group density of 2.0 groups per square nanometer (nm²) or more, and can be 2.2 groups per nm² or more, 2.5 groups per nm² or more, 3.0 groups per nm² or more, 3.5 groups per nm² or more, 4.0 groups per nm² or more, or even 4.2 groups per nm² or more. The silanol group density on the silica surface of the silica treated coating is calculated from the BET specific surface area, and the silanol group content is calculated from the amount of hydrogen evolved after the silica treated coating is dried at 120° C. for 3 hours under a vacuum of at least 2 kilopascals (15 mmHg), and the surface silanol is reacted with lithium aluminum hydride. The amorphous silica microparticles may have a BET specific surface area of 50 square meters per gram (m²/g) or more, and can be 80 m²/g or more, 100 m²/g or more, 150 m²/g or more, or even 200 m²/g or more, as determined using a Micromeritics Accelerated Surface Area & Porosimetry instrument (ASAP 2420) according to ASTM D1993. The concentration of the silica treated coating may be zero or more, and can be 0.05% or more, 0.1% or more, 0.5% or more, or even 1.0% or more, while at the same time is generally 5% or less, and can be 4% or less, 3% or less, or even 1% or less, by weight based on the total weight of the particles of the cured organosiloxane composition and the silica treated coating if present.

Processes for preparation of (D) particles of the cured organosiloxane composition are known in the art, typically comprises (i) preparing a water-based dispersion of a curable organosiloxane composition, (ii) curing the composition to produce a water-based dispersion of cured organosiloxane particles, and (iii-1) finally removing water from the water-based dispersion, desirably by heating. In preparation of the cured organosiloxane particles with the silica treated coating, the process may comprise: the steps (i) and (ii) described above, and then (iii-2) mixing the water-based dispersion of the cured organosiloxane particles obtained from step (ii) with amorphous silica microparticles or a water-based dispersion of amorphous silica microparticles, thereby forming a water-based mixture of the cured organosiloxane particles and the amorphous silica microparticles; and (iv) subjecting the mixture obtained from step (iii-2) to a rubbing unification; or heating the mixture obtained from step (iii-2) and thereafter removing the water. Heating the water-based dispersion or mixture can be conducted at a temperature range of 40 to 95° C. or 60 to 90° C., which, in step (iv) if present, can cause the particles of silica to become immobilized on the surface of the cured organosiloxane particles by the interaction in the water of the silanol groups on the surface of the silica with the functional groups such as silanol, silicon-bonded hydrogen, and silicon-bonded alkoxy located on the surface of the cured organosiloxane particles. Examples of cured organosiloxane materials suitable as (D) and methods for their preparation are disclosed, for example, in EP0685508B1 and EP0647672B1.

One common method for preparing the water-based dispersion of the curable organosiloxane composition in step (i) above comprises dispersing the curable organosiloxane composition in water, or an aqueous surfactant solution, and then generating a homogeneous dispersion therefrom by the action of a suitable device such as a homogenizer or colloid mill; or a mixing device such as an ultrasonic vibrator. Examples of the curable organosiloxane composition suitable for preparing the cured organosiloxane particles include addition reaction-curing organosiloxane compositions, condensation reaction-curing organosiloxane compositions, organoperoxide-curing organosiloxane compositions, and ultraviolet (UV)-curing organosiloxane compositions.

The ingredients for addition reaction curable organosiloxane compositions may include (a) an aliphatically unsaturated polyorganosiloxane containing two or more alkenyl groups per molecule, including those described in (A) of the curable release coating composition above, (b) a crosslinker having two or more silicon-bonded hydrogen atoms per molecule, including those described in (B) of the curable release coating composition above, and (c) a hydrosilylation reaction catalyst, including those described in (C) of the curable release coating composition above, and desirably a platinum catalyst. The resultant cured organosiloxane particles comprises a reaction product of (a) and (b). Desirably, the ingredient (a) in the curable organosiloxane composition comprises one or more linear polydiorganosiloxanes (A-3). Examples of the ingredient (a) include dimethylvinylsiloxy-terminated poly(dimethylsiloxane/methylvinylsiloxane), dimethylvinylsiloxy-terminated polydimethylsiloxane, trimethylsiloxy-terminated poly(dimethylsiloxane/methylvinylsiloxane), dimethylvinylsiloxy-terminated methyl silsesquioxane, vinyl-terminated polydimethylsiloxane, or mixtures thereof. Desirably, the ingredient (b) in the curable organosiloxane composition is selected from trimethylsiloxy-terminated poly(dimethylsiloxane/methylhydrogensiloxane), trimethylsiloxy-terminated polymethylhydrogensiloxane, hydrogen-terminated polydimethylsiloxane, hydrogen-terminated poly(dimethylsiloxane/methylhydrogensiloxane), hydrogen-terminated polymethylhydrogensiloxane, or mixtures thereof. More desirably, the cured organosiloxane particles comprise a reaction product of poly(dimethylsiloxane/methylhydrogen siloxane) with dimethylvinylsiloxy-terminated poly(dimethylsiloxane/methylvinylsiloxane), a reaction product of poly(dimethylsiloxane/methylhydrogensiloxane) with dimethylvinylsiloxy-terminated methyl silsesquioxane and vinyl-terminated dimethyl siloxane, a reaction product of poly(dimethylsiloxane/methylhydrogensiloxane) with dimethylvinylsiloxy-terminated poly(dimethylsiloxane/methylvinylsiloxane), or mixtures thereof.

The curable release coating composition of the present invention may comprise (D) particles of the cured organosiloxane composition, optionally with silica treated coating, at a centration of 0.1% or more, and can be 0.15% or more, 0.2% or more, 0.25% or more, 0.3% or more, 0.35% or more, 0.4% or more, 0.45% or more, or even 0.5% or more, while at the same time is generally 5% or less, and can be 4.5% or less, 4% or less, 3.5% or less, 3% or less, 2.5% or less, 2% or less, 1.8% or less, 1.5% or less, 1.4% or less, 1.3% or less, 1.2% or less, 1% or less, 0.8% or less, or even 0.5% or less, by weight based on the weight of the curable release coating composition excluding solvent if present.

The curable release coating composition of the present invention may comprise or be free of (E) one or more hydrosilylation reaction inhibitors (also as “inhibitor”), which are useful for altering rate of reaction of the silicon-bonded hydrogen atoms and alkenyl groups in the composition, as compared to reaction rate of the same composition but with the inhibitor omitted. Examples of suitable inhibitors include acetylenic alcohols such as 2-methyl-3-butyn-2-ol, dimethyl hexynol, 3,5-dimethyl-1-hexyn-3-ol, 1-butyn-3-ol, 1-propyn-3-ol, 2-methyl-3-butyn-2-ol, 3-methyl-1-butyn-3-ol, 3-methyl-1-pentyn-3-ol, 3-phenyl-1-butyn-3-ol, 4-ethyl-1-octyn-3-ol, 3,5-dimethyl-1-hexyn-3-ol, and 1-ethynyl-1-cyclohexanol (ETCH); cycloalkenylsiloxanes such as methylvinylcyclosiloxanes exemplified by 1,3,5,7-tetramethyl-1,3,5,7-tetravinylcyclotetrasiloxane, and 1,3,5,7-tetramethyl-1,3,5,7-tetrahexenylcyclotetrasiloxane; ene-yne compounds such as 3-methyl-3-penten-1-yne and 3,5-dimethyl-3-hexen-1-yne; triazoles such as benzotriazole; phosphines; mercaptans; hydrazines; amines such as tetramethyl ethylenediamine, 3-dimethylamino-1-propyne, n-methylpropargylamine, propargylamine, and 1-ethynylcyclohexylamine; fumarates including dialkyl fumarates such as diethyl fumarate, dialkenyl fumarates such as diallyl fumarate, dialkoxyalkyl fumarates; maleates such as diallyl maleate and diethyl maleate; nitriles; ethers; or mixtures thereof.

The inhibitor useful in the present invention may be present at a concentration of zero or more, and can be 0.001% or more, 0.0025% or more, or even 0.01% or more, while at the same time is generally 5% or less, and can be 1% or less, 0.5% or less, or even 0.25% or less, by weight based on the weight of the release coating composition excluding solvent if present.

The curable release coating composition of the present invention may comprise or be free of (F) one or more anchorage additives. Suitable anchorage additives may include, for example, a reaction product of a vinyl alkoxysilane and an epoxy-functional alkoxysilane; a reaction product of a vinyl acetoxysilane and epoxy-functional alkoxysilane; and a blend and/or a reaction product of a polyorganosiloxane having at least one aliphatically unsaturated hydrocarbon group and at least one hydrolyzable group per molecule and an epoxy-functional alkoxysilane (e.g., a blend or reaction product of a hydroxy-terminated, vinyl functional polydimethylsiloxane with glycidoxypropyltrimethoxysilane). Examples of suitable epoxy-functional alkoxysilanes include 3-glycidoxypropyltrimethoxysilane, 3-glycidoxypropyltriethoxysilane, (epoxycyclohexyl)ethyldimethoxysilane, (epoxycyclohexyl)ethyldiethoxysilane, or mixtures thereof. Suitable anchorage additives and methods for their preparation are disclosed, for example, in U.S. Patent Application Publication Numbers 2003/0088042, 2004/0254274, and 2005/0038188; and EP 0 556 023. Suitable commercially available anchorage additives may include, for example, SYL-OFF™ 297, SYL-OFF™ 397, and SYL-OFF™ SL 9250 all available from Dow Silicones Corporation of Midland, Michigan, USA (SYL-OFF is a trademark of Dow Silicones Corporation).

The anchorage additive useful in the present invention may be present at a centration of zero or more, and can be 0.01% or more, 0.05% or more, 0.1% or more, 0.2% or more, 0.3% or more, 0.4% or more, or even 0.5% or more, while at the same time is generally 5% or less, and can be 4% or less, 3% or less, 2% or less, 1.5% or less, or even 1% or less, by weight based on the weight of the curable release coating composition excluding solvent if present.

The curable release coating composition of the present invention may comprise or be free of (G) one or more solvents. Suitable solvents may include, for example, polyalkylsiloxanes, alcohols, ketones, aromatic hydrocarbons, aliphatic hydrocarbons, glycol ethers, tetrahydrofuran, mineral spirits, naphtha, tetrahydrofuran, mineral spirits, naphtha, or mixtures thereof. The solvent may include one or more organic solvents including an alcohol such as methanol, ethanol, isopropanol, butanol, or n-propanol; a ketone such as acetone, methylethyl ketone, or methyl isobutyl ketone; an aromatic hydrocarbon such as benzene, toluene, or xylene; an aliphatic hydrocarbon such as heptane, hexane, or octane; a glycol ether such as propylene glycol methyl ether, dipropylene glycol methyl ether, propylene glycol n-butyl ether, propylene glycol n-propyl ether, or ethylene glycol n-butyl ether, tetrahydrofuran; mineral spirits; naphtha; or combinations thereof. Desirably, the solvent is heptane.

The solvent may be present at a concentration of zero or more, 2% or more, 20% or more, or even 50% or more, while at the same time is generally 99% or less, and can be 50% or less, 20% or less, or even 2% or less, by weight based on the weight of the curable release coating composition. The solvent may be added during preparation of the release coating composition, for example, to aid mixing and delivery of one or more components in the release coating composition described above. For example, the hydrosilylation catalyst may be delivered in a solvent. All or a portion of the solvent may optionally be removed after the release coating composition is prepared.

The curable release coating composition of the present invention may comprise or be free of (H) organic modified functional silica particles having an average particle size of 3 μm to 15 μm, as measured using Malvern Mastersizer Hydro 2000SM according to ASTM D4464-15. The organic modified silica particles may be high porosity silica particles which have greater than 90% of porosity. The functional silica particles have on their surface one or more organic functional groups such as trimethylsilyl, triethylsilyl, dimethylvinylsilyl, and dimethylphenylsilyl. A method for manufacturing of component (H) is not limited, including, for example, U.S. Pat. No. 7,470,725 describes a method comprising the following steps: a) modifying the surface of silica aerogels by a silylation agent; and b) drying the surface-modified gel obtained in step a). Such organic modified functional silica particles are commercially available as DOWSIL™ VM-2270 Aerogel Fine Particles from The Dow Chemical Company (DOWSIL is a trademark of The Dow Chemical Company). The organic modified functional silica particles may be present at a concentration of 5% or less, 0.5% or less, 0.1% or less, or even zero, by weight of the curable release coating composition excluding solvent if present. To further improve transparency of the release coating, the curable release coating composition is desirably in the substantial absence of organic modified functional silica particles. “Substantial absence of organic modified functional silica particles” refers to less than 0.1%, less than 0.05%, less than 0.01%, less than 0.005%, or even zero, by weight based on the weight of the curable release coating composition excluding solvent if present.

The curable release coating composition of the present invention may be prepared by admixing the aliphatically unsaturated polyorganosiloxane (A), the crosslinker (B), the hydrosilylation reaction catalyst (C), and the particles of the cured organosiloxane composition (D); and optionally other components including the hydrosilylation reaction inhibitor (E), the anchorage additive (F), and/or the solvent (G). The curable release coating composition can be prepared as one part composition, or as a multiple part composition, in which the crosslinker and catalyst are stored in separate parts, until the parts are combined at the time of use (e.g., shortly before application to a substrate).

The curable release coating composition of the present invention is suitable for use in forming a release coating comprising a cured product of the curable release coating composition, i.e., a release coating formed by curing the curable release coating composition. The release coating with excellent transparent appearance and anti-blocking property, as well as desirable low release force and high sustained adhesion strength, make them suitable for use in electronic devices applications, particularly when transparency is desired, such as release liners for silicone pressure sensitive adhesives used in electronic device applications such as touch panels for tape release, label release and/or adhesive transfer film. The present invention also relates to a release line comprising a substrate and the release coating (which is formed by curing the release coating composition (e.g., via hydrosilylation reaction) residing on at least one surface of the substrate.

The present invention also relates to a method of preparing the release liner, comprising: applying the curable release coating composition to at least one surface of a substrate such a film, and curing the curable release coating composition to form a release coating (also as “cured release coating”) on the surface of the substrate, thereby forming the release liner. The release liner comprises the substrate and the release coating on at least one surface of the substrate. The curable release coating composition can be applied to both surfaces of the substrate. The curable release coating composition can be applied to the substrate by any convenient means such as spraying, doctor blade, dipping, screen printing or by a roll coater, e.g., an offset web coater, kiss coater, etched cylinder coater or multiple rolls coater. The curable release coating composition can be applied to any substrate, typically a sheet-form substrate, including, for example, polymeric films including polyester such as polyethylene terephthalate (PET), polyethylene, polypropylene, or polystyrene films; a paper substrate including plastic coated paper such as paper coated with polyethylene, glassine, super calender paper, or clay coated kraft; and metal foils such as aluminum foil. Desirably, the substrate can be PET films. Desirably, the curable release coating composition is applied on at least one surface of a sheet-form substrate with a multiple rolls coater.

The method of preparing the release liner may optionally further comprise: treating the surface of the substrate before applying the curable release coating composition. Treating the substrate may be performed by any convenient means, such as applying a primer, or subjecting the substrate to corona-discharge treatment, etching, or plasma treatment before coating the curable release coating composition.

The method of preparing the release liner may optionally further comprise: removing solvent if present, before or during curing the curable release coating composition, which may be performed by any conventional means, such as heating at 50° C. to 100° C. for a time sufficient to remove all or a portion of the solvent. The method of preparing the release liner may further comprise curing the curable release coating composition to form a release coating on the surface of the substrate. Curing may be performed by any conventional means such as heating at temperatures depending on coating lines used, typically in a range of 100 to 240° C., 110 to 160° C., or 120 to 150° C. for a time sufficient to cure the release coating composition. For example, curing can be conducted at 120 to 160° C. for off-line coating in an oven or at 200 to 240° C. for in-line coating in an oven. Curing time can be from 1 second to 10 seconds, from 2 seconds to 20 seconds, or from 5 seconds to 30 seconds. The above heating step and curing step can be performed in an oven, e.g., an air circulation oven or tunnel furnace or by passing the coated film around heated cylinders.

The coat weight of the release coating can be 0.05 grams per square meter (g/m²) to 2.0 g/m². The curable release coating composition of the present invention can provide the release liner made therefrom (i.e., release liners comprising the substrate and the release coating on at least one surface of the substrate) with one or more of the following properties: clear appearance (a haze value<3.5), anti-blocking property, a low release force (RF-RT<5.0 grams per inch (gin)), and a high subsequent adhesive strength (SAS>85%) at low coat weights (e.g., 1.3 g/m² or less). These properties are determined according to the test methods described below in the Examples section.

The release liners prepared as described above can be used to protect pressure sensitive adhesives. Customers may coat a liquid pressure sensitive adhesive composition directly on the release liner and remove the solvent or water by heat, alternatively by UV cure, then laminate with substrates and rewind to rolls. Alternatively, customers may laminate the release liner with dry pressure sensitive adhesive or sticky film for tapes, labels or die-cutting applications. The present invention also relates to use of the release liner for a silicone pressure sensitive adhesive article in an electronic device application.

### EXAMPLES

Some embodiments of the invention will now be described in the following Examples, wherein weight-percent (wt %) values are relative to the weight of a composition, unless otherwise specified. Table 1 lists the materials for use in the release coating compositions of the samples described herein below. Note: “Vi” represents vinyl, “Me” represents methyl.

TABLE 1

| Component | Chemical description | Commercial Source |
|---|---|---|
| Vi Polymer | 97.4 wt % of a polyorganosiloxane including | The Dow |
| A-1 | SiO_{4/2}, Me₂SiO_{2/2}, Me₃SiO_{1/2}, and | Chemical Company |
| | ViMe₂SiO_{1/2} units, having a viscosity of 450 | |
| | mPa · s at 25° C. and a vinyl content of 0.47 wt % | |
| | 2 wt % of a polyorganosiloxane including | |
| | SiO_{4/2}, Me₂SiO_{2/2}, Me₃SiO_{1/2}, and ViMe₂SiO_{1/2} | |
| | units, having a viscosity of 40,000 mPa · s | |
| | at 25° C. and a vinyl content of 0.20 wt % | |
| | 0.6 wt % of 1-ETHYNYL-1-CYCLOHEXANOL | |
| Vi Polymer | A polyorganosiloxane of unit formula | The Dow |
| A-2 | (Me₃SiO_{1/2})_{0.97}(ViMe₂SiO_{1/2})_{1.73}(Me₂SiO_{2/2})_{95.09} | Chemical Company |
| | (MeSiO_{3/2})_{2.21} having a viscosity of 650 mPa · s at 25° C. | |
| | and a vinyl content of 0.59 wt % | |
| Vi Polymer | A polyorganosiloxane of unit formula | The Dow |
| A-3 | (Me₃SiO_{1/2})_{2.37}(ViMe₂SiO_{1/2})_{0.67}(Me₂SiO_{2/2})_{91.66} | Chemical Company |
| | (MeSiO_{3/2})_{5.30} having a viscosity of 750 mPas at 25° C. | |
| | and a vinyl content of 0.24 wt % | |
| Vi Polymer | Gum-like trimethylsiloxy-terminated dimethylsiloxane- | The Dow |
| A-4 | methylhexenylsiloxane copolymer | Chemical Company |
| | having a vinyl content of 0.77 wt % | |
| Silica | Aerogel silica silylate, having an average particle size | DOWSIL ™ VM-2270 |
| Particles | of 3-12 μm as measured using Malvern Mastersizer | Aerogel Fine |
| | Hydro 2000SM according to ASTM D4464-15 | Particles available from |
| | | The Dow |
| | | Chemical Company |
| Epowder-1 | Elastomer powder comprising a reaction product of | The Dow |
| | poly(dimethylsiloxane/methylhydrogen siloxane) with | Chemical Company |
| | dimethylvinylsiloxy-terminated | |
| | poly(dimethylsiloxane/methylvinylsiloxane), | |
| | having an average particle size of 2-10 μm | |
| Epowder-2 | Elastomer powder comprising a reaction product of | The Dow |
| | poly(dimethylsiloxane/methylhydrogensiloxane) with | Chemical Company |
| | dimethylvinylsiloxy-terminated methyl silsesquioxane | |
| | and vinyl-terminated polydimethylsiloxane, | |
| | having an average particle size of 1-6 μm | |
| Epowder-3 | Elastomer powder comprising a reaction product of | The Dow |
| | poly(dimethylsiloxane/methylhydrogensiloxane) with | Chemical Company |
| | dimethylvinylsiloxy-terminated | |
| | poly(dimethylsiloxane/methylvinylsiloxane) with | |
| | silica, having an average particle size of 2-10 μm | |
| Anchorage | Alkoxy containing alkenyl/epoxy functional | SYL-OFF ™ SL 9176 |
| Additive | organopolysiloxane anchorage promoter | anchorage additive |
| | | available from |
| | | The Dow |
| | | Chemical Company |
| SIH | Trimethylsiloxy-endblocked | The Dow |
| Crosslinker | methylhydrogenpolysiloxane having a | Chemical Company |
| | viscosity of 20 mPas at 25° C. | |
| Catalyst | 1.5 wt % of Pt-1,3-divinyl-1,1,3,3-tetramethyldisiloxane | SYL-OFF ™ 4000 |
| | complex in dimethylvinylsiloxy-terminated | catalyst available from |
| | dimethylpolysiloxane having a viscosity | The Dow |
| | of 450 mPa · s at 25° C. | Chemical Company |
| Inhibitor | 1-ETHYNYL-1-CYCLOHEXANOL (ETCH) | BASF Corporation of |
| | | Ludwigshafe |
| Solvent | Heptane | Sinopharm Chemical |
| | | Reagent Co., Ltd. |

*Particle size of Epowder was determined using Malvern Mastersizer Hydro 2000SM (further details provided under Particle Size of Cured Organosiloxane Composition below).

### IEs 1-10 and CEs A-H Samples

Formulations for release coating composition samples are in Table 2, with the amount of each component reported in grams (g) unless otherwise indicated.

Samples were prepared by using a SpeedMixer™ DAC 400 FVZ mixer from FlackTek Inc. (South Carolina, USA) to mix the components together. To a cup of the SpeedMixer add the Vi Polymer, Epowder or Silica Particles, Anchorage Additive, SiH Crosslinker, and Inhibitor. Mix at 3,000 revolutions per minute (RPM) for 30 seconds for several rounds until homogeneous. A suitable amount of heptane solvent was added, if needed, to reach the target coat weight (CW) given in Table 2. The Catalyst was added, and the resulting mixture was mixed for 10 minutes, thereby forming a release coating composition.

The release coating composition was then coated on a PET film substrate (thickness: 50 μm) using a coater and cured via thermal addition curing in an oven at 140° C. for 30 seconds, thereby forming a release liner comprising a cured release coating on the substrate. Three samples of each release coating composition were prepared and evaluated according to the test methods described below, and the results were averaged:

### Coat Weight (CW)

The coat weight in g/m² was evaluated using X-Ray to detect the coat weight of the cured release coating on the PET film substrate with an Oxford lab-x 3500 instrument manufactured by Oxford Instruments PLC, Oxon, United Kingdom. Uncoated PET was used as a control sample (blank). The test method was FINAT Test Method No. 7 (FINAT Technical Handbook 7^{th} edition, 2005).

### Release Force—Room Temperature (“RF-RT”)

The RF-RT in g/in (0.386 centinewton per centimeter) was evaluated using the 180 degree peeling test to measure release force from the release liner. A Tesa 7475 standard tape was laminated on the cured release coating, a loaded weight of 20 grams per square centimeter (g/cm²) was placed on the resultant laminated sample and left at room temperature (RT, 25° C.) for 20 hours. After 20 hours, the loaded weight was removed, and the sample was allowed to rest for 30 minutes. The release force (“RF-RT”) was then tested by a ChemInstruments AR-1500 using FINAT Test Method No. 10 (FINAT Technical Handbook 7th edition, 2005).

### Release Force—Aging (“RF-70° C. Aging”)

The RF-70° C. aging in g/in was evaluated using the 180 degree peeling test to measure release force from the release liner. A Tesa 7475 standard tape was laminated on a cured release coating, a loaded weight of 20 g/cm² was placed on the resultant laminated sample and left at 70° C. for 20 hours. After 20 hours, the loaded weight was removed and the sample allowed to rest for 30 minutes. The release force (“RF-70° C. Aging”) was then tested by ChemInstruments AR-1500 using FINAT Test Method No. 10 (FINAT Technical Handbook 7^{th} edition, 2005).

### SAS (Subsequent Adhesive Strength, Indicator of Migration)

The SAS in % was evaluated as follows. A test tape was laminated by Nitto Denko 31B tape on the cured release coating under a loaded weight of 20 g/cm² and left at 70° C. for 20 hours. After 20 hours, the loaded weight was removed and the sample was allowed to rest 30 minutes at room temperature. Then transfer the 31B tape on a PET substrate and wait for another 1 hour. The release force (“RF(release)”) was tested by ChemInstruments AR-1500 using FINAT Test Method No. 11 (FINAT Technical Handbook 7^{th} edition, 2005). In this SAS test, a laminate 31B tape on a polytetrafluoroethylene (PTFE) substrate was tested, then the PTFE sample was treated and evaluated the same way as the cured release coating sample above, and the release force (“RF(PTFE)”) was recorded. The SAS value was recorded as RF(release)/RF(PTFE)×100%.

### Anti-Blocking Test

A 25 millimeters (mm)×150 mm uncoated PET film was laminated with the same size release liner prepared above by rolling twice in each direction with a standard FINAT test roller at a speed of approximately 10 mm per second to obtain intimate contact between the release liner and the surface of the PET film. Observe by visually inspection to determine if there is visible “wetting” on the interface of the PET film and the release liner. The sample passes if there is no visible wetting, reported as “P”. Otherwise, the sample fails if there is visible wetting, reported as “F”.

### Haze

The haze of release liners prepared above was tested by BYK Gardner Haze Gard Plus according to ASTM D1003.

### Transparency

The transparency of release liners prepared above was evaluated by visual inspection and reported as “clear” and “hazy”.

### Particle Size of Particles of Cured Organosiloxane Composition

One gram of particles of a cured organosiloxane composition and 100 milliliter (mL) ethanol were loaded in a 300 mL plastic cup and mixed by a disperser for 30 seconds. The resultant mixture was mixed by ultrasonic for 3 minutes and measured the particle size in water using Malvern Mastersizer Hydro 2000SM.

### Particle Size of Amorphous Silica Microparticles

One gram of amorphous silica microparticles and 100 mL ethanol were loaded in a 300 mL plastic cup and mixed by a disperser for 30 seconds. The resultant mixture was mixed by ultrasonic for 3 minutes and measured the particle size in water using Malvern Mastersizer Hydro 2000SM.

Characterization results of the release coating composition samples are given in Table 2.

As shown in Table 2, samples IEs 1 to 10 achieved a low release force (RF-RT<5.0 g/in) with clear appearance (e.g., a haze value of less than 3.5) and anti-blocking properties to the backside of the film, while keeping comparable SAS and RF-70° C. Aging properties tested under the same conditions, as compared to samples CEs A to H. In contrast, the samples CEs A to H as given in Table 2 failed to achieve at least one of transparency and anti-blocking requirements.

TABLE 2
Compositions and Characterization of Samples

| | CE-A | CE-B | CE-C | CE-D | IE-1 | IE-2 | IE-3 | IE-4 | IE-5 |
|---|---|---|---|---|---|---|---|---|---|
| Component | | | | | | | | | |
| Vi Polymer A-1 | 100 | 100 | 100 | 100 | 100 | 100 | 100 | 100 | 100 |
| Vi Polymer A-2 | | | | | | | | | |
| Vi Polymer A-3 | | | | | | | | | |
| Vi Polymer A-4 | | | | | | | | | |
| Silica Particles | | 0.1 | 0.5 | 1.2 | | | | | |
| Epowder-1 | | | | | 0.1 | 0.5 | 1.2 | | |
| Epowder-2 | | | | | | | | 0.5 | |
| Epowder-3 | | | | | | | | | 0.5 |
| Anchorage Additive | 0.6 | 0.6 | 0.6 | 0.6 | 0.6 | 0.6 | 0.6 | 0.6 | 0.6 |
| SiH Crosslinker | 1.84 | 1.84 | 1.84 | 1.84 | 1.84 | 1.84 | 1.84 | 1.84 | 1.84 |
| Catalyst, ppm | 130 | 130 | 130 | 130 | 130 | 130 | 130 | 130 | 130 |
| Inhibitor | 0.6 | 0.6 | 0.6 | 0.6 | 0.6 | 0.6 | 0.6 | 0.6 | 0.6 |
| Solvent* | | | | | | | | | |
| Characterization | | | | | | | | | |
| SiH/Vi Ratio | 1.6 | 1.6 | 1.6 | 1.6 | 1.6 | 1.6 | 1.6 | 1.6 | 1.6 |
| CW, g/m² | 1.215 | 1.293 | 1.221 | 1.268 | 1.288 | 1.251 | 1.307 | 1.207 | 1.242 |
| RF-RT, g/in | 3.4 | 3.3 | 2.9 | 2.8 | 3.4 | 3.3 | 3.7 | 3.2 | 3.5 |
| RF-70° C. Aging, g/in | 5.8 | 5.6 | 4.8 | 5.0 | 5.7 | 5.5 | 5.8 | 5.3 | 5.4 |
| SAS, % | 93.9 | 93.2 | 92.0 | 92.3 | 94.1 | 91.8 | 92.9 | 92.1 | 91.4 |
| Anti-blocking Test | F | P | P | P | P | P | P | P | P |
| Haze | 2.96 | 3.76 | 4.51 | 5.57 | 2.91 | 2.96 | 3.01 | 2.95 | 3.00 |
| Transparency | Clear | Hazy | Hazy | Hazy | Clear | Clear | Clear | Clear | Clear |
| | CE-E | CE-F | CE-G | CE-H | IE-6 | IE-7 | IE-8 | IE-9 | IE-10 |
| Component | | | | | | | | | |
| Vi Polymer A-1 | | | | | | | | | |
| Vi Polymer A-2 | 44 | 44 | 44 | 44 | 44 | 44 | 44 | 44 | 44 |
| Vi Polymer A-3 | 24 | 24 | 24 | 24 | 24 | 24 | 24 | 24 | 24 |
| Vi Polymer A-4 | 32 | 32 | 32 | 32 | 32 | 32 | 32 | 32 | 32 |
| Silica Particles | | 0.1 | 0.5 | 1.2 | | | | | |
| Epowder-1 | | | | | 0.1 | 0.5 | 1.2 | | |
| Epowder-2 | | | | | | | | 0.5 | |
| Epowder-3 | | | | | | | | | 0.5 |
| Anchorage Additive | 0.6 | 0.6 | 0.6 | 0.6 | 0.6 | 0.6 | 0.6 | 0.6 | 0.6 |
| SiH Crosslinker | 2.22 | 2.22 | 2.22 | 2.22 | 2.22 | 2.22 | 2.22 | 2.22 | 2.22 |
| Catalyst, ppm | 130 | 130 | 130 | 130 | 130 | 130 | 130 | 130 | 130 |
| Inhibitor | 0.6 | 0.6 | 0.6 | 0.6 | 0.6 | 0.6 | 0.6 | 0.6 | 0.6 |
| Solvent* | | | | | | | | | |
| Characterization | | | | | | | | | |
| SiH/Vi Ratio | 1.6 | 1.6 | 1.6 | 1.6 | 1.6 | 1.6 | 1.6 | 1.6 | 1.6 |
| CW, g/m² | 1.338 | 1.340 | 1.277 | 1.295 | 1.334 | 1.226 | 1.327 | 1.202 | 1.270 |
| RF-RT, g/in | 2.6 | 2.8 | 2.5 | 2.6 | 3.0 | 2.9 | 3.0 | 2.8 | 2.9 |
| RF-70° C. Aging, g/in | 4.0 | 4.2 | 3.9 | 4.3 | 4.7 | 4.5 | 4.8 | 4.5 | 4.5 |
| SAS, % | 90.0 | 89.3 | 87.1 | 88.9 | 89.2 | 87.9 | 88.4 | 89.4 | 88.9 |
| Anti-blocking Test | F | P | P | P | P | P | P | P | P |
| Haze | 2.93 | 3.75 | 4.53 | 5.65 | 2.90 | 2.94 | 3.02 | 2.92 | 2.98 |
| Transparency | Clear | Hazy | Hazy | Hazy | Clear | Clear | Clear | Clear | Clear |

Note:
“SiH/Vi ratio” refers to molar ratio of SiH functionality from the crosslinker to vinyl functionality.
*Solvent (Heptane) used for each sample was added in a suitable amount to reach the target coat weight (CW) given in Table 2.

1. A curable release coating composition comprising:
(A) an aliphatically unsaturated polyorganosiloxane having two or more alkenyl groups per molecule;
(B) a crosslinker having two or more silicon-bonded hydrogen atoms per molecule in an amount sufficient to provide a molar ratio of silicon-bonded hydrogen atoms to alkenyl groups in the curable release coating composition of 0.8:1 to 5:1;
(C) a hydrosilylation reaction catalyst in a catalytic amount; and
(D) from 0.01% to 5% by weight, based on the weight of the curable release coating composition excluding solvent if present, of particles of a cured organosiloxane composition, optionally with silica treated coating, having an average particle size of 0.5 to 30 micrometers.

2. The release coating composition of claim 1, further comprising a hydrosilylation reaction inhibitor, an anchorage additive, a solvent, or mixtures thereof.

3. The release coating composition of claim 1, wherein particles of the cured organosiloxane composition comprise a reaction product of (a) an aliphatically unsaturated polyorganosiloxane containing two or more alkenyl groups per molecule and (b) a crosslinker having two or more silicon-bonded hydrogen atoms per molecule, wherein (a) is selected from dimethylvinylsiloxy-terminated poly(dimethylsiloxane/methylvinylsiloxane), dimethylvinylsiloxy-terminated polydimethylsiloxane, trimethylsiloxy-terminated poly(dimethylsiloxane/methylvinylsiloxane), dimethylvinylsiloxy-terminated methyl silsesquioxane, vinyl-terminated polydimethylsiloxane, or mixtures thereof.

4. The release coating composition of claim 1, comprising from 0.1% to 2% by weight of particles of the cured organosiloxane composition, based on the weight of the curable release coating composition excluding solvent if present.

5. The release coating composition of claim 1, wherein the aliphatically unsaturated polyorganosiloxane is selected from a Q-branched polyorganosiloxane, a silsesquioxane, a linear polyorganosiloxane, or combinations thereof.

6. The release coating composition of claim 5, wherein the Q-branched polyorganosiloxane has unit formula (A-I):
(R¹₃SiO_{1/2})ₐ(R²R¹₂SiO_{1/2})_{b}(R¹₂SiO_{2/2})_{c}(R²R¹SiO_{2/2})_{c′}(SiO_{4/2})_{d} (A-I)
where each R¹ is independently a monovalent hydrocarbon group free of aliphatic unsaturation or a monovalent halogenated hydrocarbon group free of aliphatic unsaturation, each R² is independently an alkenyl group, subscript a≥0, subscript b>0.995≥c+c′≥15, and subscript d>0;
wherein the silsesquioxane has unit formula (A-II):
(R¹₃SiO_{1/2})ₑ(R²R¹₂SiO_{1/2})_{f}(R¹₂SiO_{2/2})_{g}(R¹SiO_{3/2})ₕ (A-II)
where each R¹ is independently a monovalent hydrocarbon group free of aliphatic unsaturation or a monovalent halogenated hydrocarbon group free of aliphatic unsaturation, each R² is independently an alkenyl group, subscript e≥0, subscript f>0, subscript g is 15 to 995, and subscript h>0; and
wherein the linear polydiorganosiloxane has unit formula selected from (A-III-1), (A-III-2), or combinations thereof:
(R¹₂R²SiO_{1/2})₂(R¹₂SiO)ₙ(R¹R²SiO)ₒ (A-III-1)
(R¹₃SiO_{1/2})₂(R¹₂SiO)ₚ(R¹R²SiO)_{q} (A-III-2)
where each R¹ is independently a monovalent hydrocarbon group free of aliphatic unsaturation or a monovalent halogenated hydrocarbon group free of aliphatic unsaturation, each R² is independently an alkenyl group, subscript n is 5 to 10,000, and subscript o has a value sufficient to provide an alkenyl content of 0.01% to 5.0% by weight, based on weight of the polydiorganosiloxane of unit formula (A-III-1); subscript p is 5 to 10,000, and subscript q is sufficient to provide an alkenyl content of 0.01% to 5.0% by weight, based on weight of the polydiorganosiloxane of unit formula (A-III-2).

7. The release coating composition of claim 1, wherein the crosslinker has unit formula (B-I):
(R¹₃SiO_{1/2})₂(R¹₂SiO_{2/2})ₖ(R¹HSiO_{2/2})ₘ (B-I)
where each R¹ is independently a monovalent hydrocarbon group free of aliphatic unsaturation or a monovalent halogenated hydrocarbon group free of aliphatic unsaturation, subscript k≥0, subscript m>0, and a quantity (m+k) is 8 to 400.

8. The release coating composition of claim 1, wherein the hydrosilylation reaction catalyst is present in an amount sufficient to provide 1 ppm to 1000 ppm by weight of a platinum group metal, based on the weight of the curable release coating composition excluding solvent if present.

9. The release coating composition of claim 1, wherein the particles of the cured organosiloxane composition with the silica treated coating comprise amorphous silica microparticles immobilized on the surface of particles of the cured organosiloxane composition.

10. A method of preparing a release liner comprising a release coating on at least one surface of a substrate, comprising:
optionally treating at least one surface of the substrate,
1) applying the curable release coating composition of claim 1, to the surface of the substrate,
optionally 2) removing solvent, if present; and
3) curing the composition to form the release coating on the surface of the substrate.

11. A release liner comprising a substrate and a release coating residing on at least one surface of the substrate, wherein the release coating is formed by curing the curable release coating composition of claim 1.

12. The release liner of claim 11, having a haze value of less than 3.5 as determined according to ASTM D1003.
